(19) United States
(12) Patent Application Publication
(10) Pub. No.: US 2026/0058037 A1
(43) Pub. Date: Feb. 26, 2026

(54) COMMUNICATION CABLE AND COMMUNICATION CABLE ASSEMBLY

(71) Applicant: HIRAKAWA HEWTECH CORPORATION, Tokyo (JP)

(72) Inventor: Tomoki KUMAGAI, Date-shi, Fukushima (JP)

(21) Appl. No.: 19/303,992

(22) Filed: Aug. 19, 2025

(30) Foreign Application Priority Data
Aug. 21, 2024 (JP) 2024-139920

(51) Int. Cl. H01B 11/10; H01R 13/66

(52) U.S. Cl. CPC H01B 11/1033; H01R 13/665

(57) ABSTRACT

A communication cable includes two first differential pair wires for transmitting high-speed differential signals, a second differential pair wire for transmitting low-speed differential signals, a power wire, a ground wire, and a configuration channel wire for detecting the front and back orientation of a plug, and the communication cable is devoid of other first differential pair wires than the two first differential pair wires.

### CROSS-REFERENCE TO RELATED APPLICATIONS

The present patent application claims the priority of Japanese patent application No. 2023-139920 filed on Aug. 21, 2024, and the entire contents thereof are hereby incorporated by reference.

### TECHNICAL FIELD

This disclosure relates to communication cables and communication cable assemblies.

### BACKGROUND OF THE INVENTION

In recent years, transmission cables that can reduce costs and improve transmission characteristics have been proposed (see, for example, Patent Literature 1).

The USB (Universal Serial Bus) standard, one of the interface standards, has been developed in various ways, and the maximum transfer rate has been improved. For example, USB 1.0 and USB 1.1 have a maximum transfer rate of 12 Mbps. USB2.0 has a maximum transfer rate of 480 Mbps, USB3.0 has a maximum transfer rate of 5 Gbps, USB3.1 has a maximum transfer rate of 10 Gbps, and USB3.2 has a maximum transfer rate of 20 Gbps. On the other hand, for connectors, Type-A and Type-B connectors have been specified, but Type-C, which has a reversible connector, is specified for USB 3.1 and later.

In addition, USB cables have become capable of various types of communication with a single cable. This has led to an increase in the complexity of the core wire configuration and the number of cores. For example, it is recommended that USB 2.0 has four cores, USB 3.0 has eight cores, and USB Type-C has fifteen cores.

The transmission cable described in Patent Literature 1 is a transmission cable compliant with the USB Type-C standard. This transmission cable is a 17-core cable that includes eight coaxial wires (for 10 Gbps transmission), four signal wires (a first SBU wire, a second SBU wire, a configuration channel (CC) wire, and a Vconn wire), one power wire, two ground wires, and a pair of twisted pair wires.

### CITATION LIST

Patent Literature 1: JP2017-10747A

### SUMMARY OF THE INVENTION

Conventional transmission cables compliant with the USB Type-C standard are mainstream in many countries as charging cables for smartphones. In addition, there is a movement to adopt the USB Type-C standard as power cables and communication cables not only for smartphones but also for PCs, other communication devices, and imaging devices. This is thought not to standardize cable characteristics but to unify connector plugs (mating parts) and receptacles of devices to be connected to increase convenience. On the other hand, the USB Type-C standard defines specifications for both the cable and the connector. The cable outer diameter (cable diameter) is also limited due to the size of the USB Type-C standard-compliant connector board. Therefore, the conductor cross-sectional area of each core wire cannot be increased, and the communication quality deteriorates when the cable length is long. In addition, although the Type-C standard allows data transfer and power supply to be performed through a single cable, the problem is that if one of the communication distance (the distance over which communication can be carried out) and the power supply distance (the distance over which power can be supplied) is shorter than the other, the cable length is limited by the shorter of the two distances.

Therefore, it is an object of the invention to provide a communication cable and a communication cable assembly that allow use of a reversible plug which can be inserted into a receptacle even with front and back reversed, and also allow communication and power supply distances to be increased relative to a cable diameter.

The first aspect of the present invention provides a communication cable having both terminal ends electrically connected to a pair of plug connectors, and comprising;
two first differential pairs that transmit a high-speed differential signal;
not less than one power wire and not less than one ground wire that supply power to a device connected to the terminal end; and
a configuration channel wire to detect front/back orientation of the plug connectors, wherein any first differential pairs other than the two first differential pairs are not included.
The second aspect of the present invention provides the communication cable as described in the first aspect, wherein a signal wire constituting the first differential pair comprises a conductor at the center and an insulation layer covering the conductor, and a ratio of a conductor diameter of the conductor to a cable diameter is not less than 0.06.
The third aspect of the present invention provides the communication cable as described in the second aspect, wherein each of the power wire and the ground wire comprises a conductor and an insulation layer covering the conductor, a ratio of conductor diameters of the conductors of the power wire and the ground wire to the cable diameter is not less than 0.10, and when including a plurality of the power wires and a plurality of the ground wires, each of the conductor diameters is a conductor diameter converted so as to be equivalent to that of a single wire so that the resistance value is the same.
The fourth aspect of the present invention provides the communication cable as described in the first aspect, wherein a signal wire constituting the first differential pair comprises a conductor at the center and an insulation layer covering the conductor, and the conductor of the signal wire has a cross-sectional area of not less than 0.06 mm².
The fifth aspect of the present invention provides the communication cable as described in the fourth aspect, wherein each of the power wire and the ground wire comprises a conductor and an insulation layer covering the conductor, the conductors of the power wire and the ground wire have a cross-sectional area of not less than 0.30 mm², and when including a plurality of the power wires and a plurality of the ground wires, each of the cross-sectional areas is the sum of respective cross-sectional areas of the conductors.
The sixth aspect of the present invention provides the communication cable as described in the first aspect, wherein the number of cores is 6 or more and 14 or less.
The seventh aspect of the present invention provides the communication cable as described in the first aspect further comprising: a second power wire.
The eight aspect of the present invention provides the communication cable as described in the first aspect further comprising: a second differential pair that transmits a low-speed differential signal.
The ninth aspect of the present invention provides the communication cable as described in the first aspect, wherein, instead of the ground wire, a wire material that serves as a ground wire to supply power to a device connected to the terminal end is used.
The tenth aspect of the present invention provides a communication cable assembly, comprising:
the communication cable as described in any one of the first to ninth aspects; and
the pair of plug connectors electrically connected to both terminal ends of the communication cable.
The eleventh aspect of the present invention provides the communication cable assembly as described in the tenth aspect, wherein one of the pair of plug connectors comprises a circuit element in which a value of power suppliable to the device is recorded.

### Advantageous Effects of the Invention

According to the invention, it is possible to provide a communication cable and a communication cable assembly that allow use of a reversible plug which can be inserted into a receptacle even with front and back reversed, and also allow communication and power supply distances to be increased relative to a cable diameter.

### BRIEF DESCRIPTION OF DRAWINGS

FIGS. 1A and 1B are plan views showing an example of a communication cable assembly in the first embodiment of the present invention.

FIG. 2 is a cross-sectional view showing an example of a communication cable shown in FIGS. 1A and 1B.

FIGS. 3A and 3B show a connector substrate compatible with a cable compliant with the USB Type-C standard, wherein FIG. 3A is a plan view when the connector substrate is viewed from the front side, and FIG. 3B is a plan view when the connector substrate is viewed from the back side.

FIGS. 4A and 4B show an example of a connector substrate in the first embodiment, wherein FIG. 4A is a plan view when the connector substrate is viewed from the front side, and FIG. 4B is a plan view when the connector substrate is viewed from the back side.

FIGS. 5A and 5B are explanatory diagrams illustrating how a first differential pair in the first embodiment is connected to the connector substrate shown in FIGS. 4A and 4B, wherein FIG. 5A is a plan view when the connector substrate is viewed from the front side, and FIG. 5B is a plan view when the connector substrate is viewed from the back side.

FIG. 6 is a cross-sectional view showing an example of the communication cable in the second embodiment of the invention.

FIG. 7 is a cross-sectional view showing an example of the communication cable in the third embodiment of the invention.

FIGS. 8A and 8B are explanatory diagrams illustrating how the first differential pair in the third embodiment is connected to the connector substrate shown in FIGS. 4A and 4B, wherein FIG. 8A is a plan view when the connector substrate is viewed from the front side, and FIG. 8B is a plan view when the connector substrate is viewed from the back side.

FIG. 9A is a diagram illustrating the attenuation characteristics when the cable length is 3 m.

FIG. 9B is a diagram illustrating the attenuation characteristics for cable lengths corresponding to the respective communication distances.

### DETAILED DESCRIPTION OF THE INVENTION

Embodiments of the invention will be described below with reference to the drawings. In each drawing, constituent elements having substantially the same functions are denoted by the same reference signs and overlapping explanations thereof will be omitted.

### First Embodiment

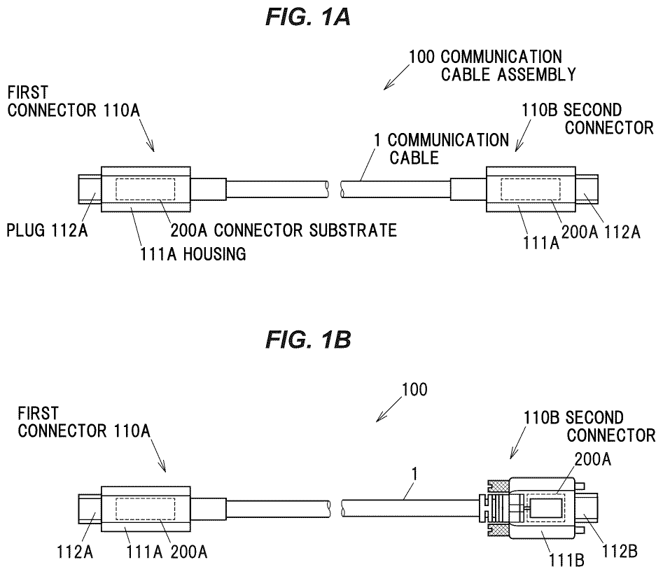

FIGS. 1A and 1B are plan views showing an example of a communication cable assembly in the first embodiment of the invention. This communication cable assembly 100 includes a communication cable 1 of a predetermined length within a communication distance and within a power supply distance, a first plug connector (hereinafter, abbreviated as the “first connector”) 110A connected to one of terminal ends of the communication cable 1, and a second plug connector (hereinafter, abbreviated as the “second connector”) 110B connected to the other terminal end of the communication cable 1.

The communication cable 1 is a 10-core cable which has a reduced number of cores as compared to the core configuration of cables compliant with the USB Type-C standard. That is, the cables compliant with the USB Type-C standard have four pairs of high-frequency signal wires (a SSTX1 wire, a SSRX1 wire, a SSTX2 wire, a SSRX2 wire), but the high-frequency signal wires in the communication cable 1 are limited to two pairs (e.g., the SSTX1 wire and the SSRX1 wire).

In addition, while the cables compliant with the USB Type-C standard have signal wires (a SBU1 wire, a SBU2 wire) for an alternate mode (HDMI (registered trademark) DisplayPort, etc.), the communication cable 1 does not have an alternate mode, in other words, does not include signal wires (the SBU1 wire, the SBU2 wire) or is configured to be dedicated to USB signals. However, the signal wires (the SBU1 wire, the SBU2 wire) may be added as necessary.

With the above-described configuration, the number of cores can be reduced, and when the cable diameter is the same as conventional cables, the conductor diameters of the SSTX1 wire and the SSRX1 wire can be increased and the communication distance can thereby be increased. In addition, the conductor diameters of a power wire and a ground wire to supply power to a device connected to a terminal end of the communication cable 1 can be increased, and the power supply distance can thus be increased. In other words, the communication distance and the power supply distance can be increased relative to the cable diameter. In addition, by keeping a CC wire compliant with the USB Type-C standard, it is possible to employ connectors compliant with the USB Type-C standard, i.e., reversible plugs that can be inserted into receptacles even when the front and back (top and bottom) are reversed. Furthermore, since the number of cores can be reduced, the thicknesses of the cores can be increased, which provides advantages in terms of selection of materials for the resin layer and in terms of manufacturing, etc., as will be described later. In this regard, to receive benefits from standardizing connectors compliant with the USB Type-C standard, it is sufficient that at least the shape and structure of a fitting portion of the connector match the shape and structure of the USB Type-C fitting portion of a device to be connected, and the shape and structure of the connector substrate and cable, except for the fitting portion of the connector, do not need to be compliant with the USB Type-C standard. In addition, since it is possible to increase the cable length without causing deterioration in communication quality and also reduce the weight, the cable can be used, e.g., for in-vehicle devices.

The first connector 110A is connected to, e.g., a receptacle provided on a computer (hereinafter, referred to as the first device), and includes a housing 111A made of a resin, a plug 112A provided so as to be exposed from the housing 111A, and a connector substrate 200A arranged in the housing 111A. The connector substrate 200A of the first connector 110A electrically connects the plug 112A to one terminal end of the communication cable 1. The plug 112A is an example of the fitting portion.

The second connector 110B is connected to, e.g., a receptacle provided on a peripheral device (hereinafter, referred to as the second device), and is constructed from the same connector as the first connector 110A, as shown in FIG. 1A. That is, the second connector 110B includes a housing 111A made of a resin, a plug 112A provided so as to be exposed from the housing 111A, and a connector substrate 200A arranged in the housing 111A. The connector substrate 200A of the second connector 110B electrically connects the plug 112A to the other terminal end of the communication cable 1.

Examples of the first device and the second device connected to the first connector 110A or the second connector 110B include devices such as personal computers, tablet terminals, smartphones, digital cameras, printers, computer mice, earphones and USB memories, and rechargers, etc. The devices may have a charging function. The first device and the second device are devices compliant with, e.g., the USB PD (Power Delivery) standard and have a PD control unit. The PD control unit performs PD communication compliant with the USB PD standard.

The identical connectors are used as the first connector 110A and the second connector 110B in the first embodiment as shown in FIG. 1A, but different connectors may be used as shown in FIG. 1B. For example, the second connector 110B includes a housing 111B made of a resin and provided with a screw to prevent the connector from coming off, a plug 112B provided so as to be exposed from the housing 111B, and a connector substrate 200A arranged in the housing 111B. The identical substrates are used as the connector substrate 200A of the first connector 110A and the connector substrate 200A of the second connector 110B in the first embodiment, but different substrates may be used. Cables with a plug of the present embodiments connected to one end and a plug compliant with the Type-A standard or Type-B standard connected to the other end (USB Type-C legacy cable) are not included in the present embodiments. The plug 112B is an example of the fitting portion.

### Configuration of Communication Cable

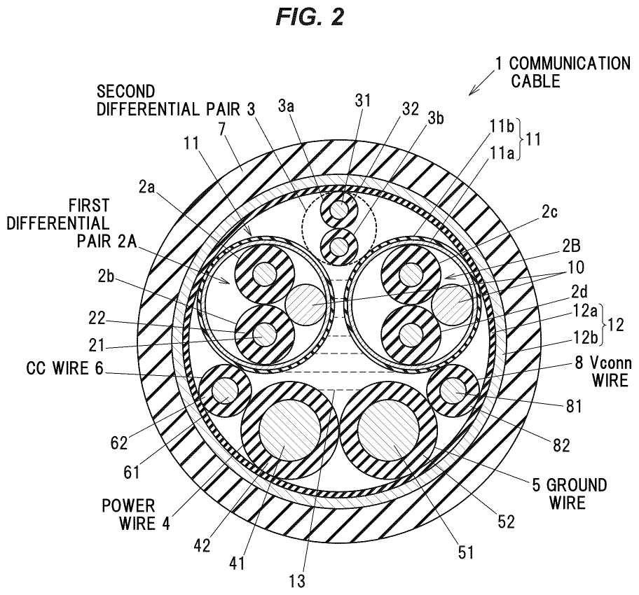

FIG. 2 is a cross-sectional view showing an example of the communication cable 1 shown in FIGS. 1A and 1B. This communication cable 1 is a 10-core cable that has two first differential pairs 2A, 2B transmitting high-speed differential signals (e.g., 5 Gbps to 20 Gbps), a second differential pair 3 transmitting low-speed differential signals (e.g., 480 Mbps), not less than one power wire 4 (Vbus wire), not less than one ground wire 5, a configuration channel wire (hereinafter referred to as the “CC wire”) 6 to detect the front/back orientation of a plug compliant with the USB Type-C standard, and a power wire for the circuit in the plug (hereinafter, referred to as the “Vconn wire”) 8 compliant with the USB Type-C standard, and does not have any first differential pairs other than the two first differential pairs 2A, 2B. However, the communication cable 1 is not limited to the 10-core cable and may be a cable with not more than 8 cores, or not more than 9 cores, or not more than 14 cores. Having not more than 14 cores allows for differentiation from the number of cores recommended for USB Type-C (15 cores). In addition, the CC wire 6 may be a wire that is not compliant with the USB Type-C standard. Likewise, the Vconn wire 8 may be a wire that is not compliant with the USB Type-C standard. The Vconn wire 8 is an example of the second power wire.

Of signal wires 2a to 2d constituting the first differential pairs 2A, 2B, the two adjacent signal wires 2a, 2b constitute a first pair of differential wires, and the other two adjacent signal wires 2c, 2d constitute a second pair of differential wires. The pair of signal wires 2a and 2b, together with a drain wire 10, are twisted together and are all covered with a shielding layer 11. A first Twinax cable is thereby formed. The other pair of signal wires 2a, 2b, together with another drain wire 10, are also twisted together and are all covered with a shielding layer 11, thereby forming a second Twinax cable. Hereinafter, the communication cable 1 using the Twinax cables as the first differential pairs 2A, 2B will be also referred to as a Twinax-type communication cable. In this regard, the twinax cable may be of a non-twisted type. The drain wire 10 is, e.g., a stranded wire formed by twisting plural metal strands together. The signal wires 2a to 2d are an example of the signal wire constituting the first differential pair.

Each of the signal wires 2a to 2d includes a conductor 21 and an insulation layer 22 that covers the conductor 21. The conductor 21 is, e.g., a stranded wire formed by twisting plural metal strands together. The insulation layer 22 is made of a resin material (e.g., cross-linked polyethylene). The conductors 21 of the signal wires 2a to 2d constituting the first differential pairs 2A, 2B have a cross-sectional area that, e.g., allows communication over a distance of at least not less than 4.0 m, preferably not less than 5.0 m, and more preferably not less than 6.0 m at a transfer rate of 5 Gbps. In particular, the cross-sectional area of the conductors 21 of the signal wires 2a to 2d is preferably not less than 0.06 mm², and more preferably not less than 0.08 mm². The cross-sectional area of the conductors 21 of the signal wires 2a to 2d is preferably also not more than 0.35 mm², more preferably not more than 0.23 mm² so that connection work to the connector substrate 200A is not difficult. Due to the size limitation of the connector substrate 200A for the fitting portion compliant with the USB Type-C standard, a ratio of the conductor diameter of the conductors 21 of the signal wires 2a to 2d to the cable diameter is preferably not less than 0.06. The conductor 21 is an example of the conductor at the center.

The shielding layer 11 includes an inner shielding layer 11a provided on the inner side and formed by wrapping a conductive tape (e.g., a tape obtained by laminating aluminum and polyester), and an outer shielding layer 11b provided on the outer side of the inner shielding layer 11a and formed by wrapping a resin tape (e.g., a polyester tape).

The second differential pair 3 is formed by twisting two signal wires 3a and 3b together. Each of the signal wires 3a and 3b includes a conductor 31 and an insulation layer 32 that covers the conductor 31. The conductor 31 is, e.g., a stranded wire formed by twisting plural metal strands together. The insulation layer 32 is made of a resin material (e.g., polyethylene).

The power wire 4 includes a conductor 41 and an insulation layer 42 that covers the conductor 41. The conductor 41 is, e.g., a stranded wire formed by twisting plural metal strands together. The insulation layer 42 is made of a resin material (e.g., fluoroplastic such as tetrafluoroethylene-ethylene (ETFE) copolymer resin, or polyvinyl chloride).

The ground wire 5 includes a conductor 51 and an insulation layer 52 that covers the conductor 51. The conductor 51 is, e.g., a stranded wire formed by twisting plural metal strands together. The insulation layer 52 is made of a resin material (e.g., fluoroplastic such as tetrafluoroethylene-ethylene copolymer resin (ETFE), or polyvinyl chloride). The ground wire 5 may be a bare wire that does not have an insulation layer on the outer circumference.

The conductor 41 of the power wire 4 and the conductor 51 of the ground wire 5 have a cross-sectional area such that, e.g., the power supply distance, with which the voltage drop when supplying power of 60 W (20 V, 3 A) is not more than 500 mV in the power wire 4 and not more the 250 mV in the ground wire 5, is at least not less than 3.0 m, preferably not less than 5.0 m, and more preferably not less than 6.0 m. In particular, each of the cross-sectional areas of the conductor 41 of the power wire 4 and the conductor 51 of the ground wire 5 is preferably not less than 0.30 mm², and more preferably not less than 0.50 mm². In this regard, as the cross-sectional areas of the conductor 41 of the power wire 4 and the conductor 51 of the ground wire 5 increase, the cable diameter becomes larger, making the connection work to the connector substrate 200A difficult. For this reason, each of the cross-sectional areas of the conductor 41 of the power wire 4 and the conductor 51 of the ground wire 5 is preferably not more than 1.5 mm², and more preferably not more than 1.0 mm² so that the connection work to the connector substrate 200A is not difficult. Plural power wires 4 and plural ground wires 5 may be used. In this case, each of the cross-sectional areas of the conductors 41 and 51 is considered as a total cross-sectional area of plural conductors. By setting the power supply distance to a similar level to the communication distance (e.g., not more than 2 m, or not more than 1 m, of difference between the communication distance and the power supply distance), it is possible to increase the distance over which data communication and power supply can be performed simultaneously. Due to the size limitation of the connector substrate 200A for the fitting portion compliant with the USB Type-C standard, a ratio of the conductor diameters of the conductor 41 of the power wire 4 and the conductor 51 of the ground wire 5 to the cable diameter is preferably not less than 0.10 and not more than 0.23.

The CC wire 6 includes a conductor 61 and an insulation layer 62 that covers the conductor 61. The conductor 61 is, e.g., a stranded wire formed by twisting plural metal strands together. The insulation layer 62 is made of a resin material (e.g., polyvinyl chloride).

The Vconn wire 8 includes a conductor 81 and an insulation layer 82 that covers the conductor 81. The conductor 81 is, e.g., a stranded wire formed by twisting plural metal strands together. The insulation layer 82 is made of a resin material (e.g., polyvinyl chloride).

The Vconn wire 8 may be used to identify a device connected to the communication cable 1 and its functions and conditions. This allows a host as the first device (usually a computer or a recharger) to supply appropriate power to the device connected to the communication cable 1. For example, a docking station or display as the second device compliant with the USB Type-C standard communicates with the host through the Vconn wire 8 and requests the necessary power level or function. This allows for identification of the connected device and ensures that the necessary power or function is provided. A cable equipped with an IC chip (eMaker) (an active cable) may use the Vconn wire 8 to efficiently transmit data or power. The IC chip (eMaker) inside the cable communicates with the host through the Vconn wire 8 and establishes appropriate power and data transmission protocols. This allows for faster data transfer and more appropriate power supply. The Vconn wire 8 is also used to supply power to a device in some cases. For example, a device connected to a USB Type-C port (e.g., earphones or a computer mouse) can receive power through the Vconn wire 8. This results in that the device does not need its own power source, allowing for a simpler, more compact design.

The first differential pairs 2A, 2B, the second differential pair 3, the power wire 4, the ground wire 5, the CC wire 6 and the Vconn wire 8, together with a filler string 13, are covered with a shielding layer 12 which is in turn covered with a sheath 7. The sheath 7 is made of a resin material (e.g., polyvinyl chloride) with a thickness of about 0.6 to 0.9 mm. The filler string 13 is made of a fibrous material (e.g., cotton, silk, etc.). The filler string 13 is an example of a filler.

The shielding layer 12 includes an inner shielding layer 12a provided on the inner side and formed by wrapping a conductive tape (e.g., a tape obtained by laminating aluminum and polyester), and an outer shielding layer 12b provided on the outer side of the inner shielding layer 12a and formed of a metal braid (e.g., a tin-plated soft copper wire braid).

### Configuration of Connector Substrate

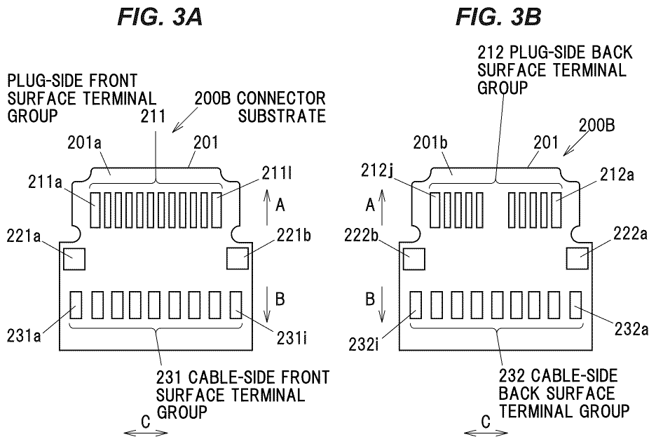

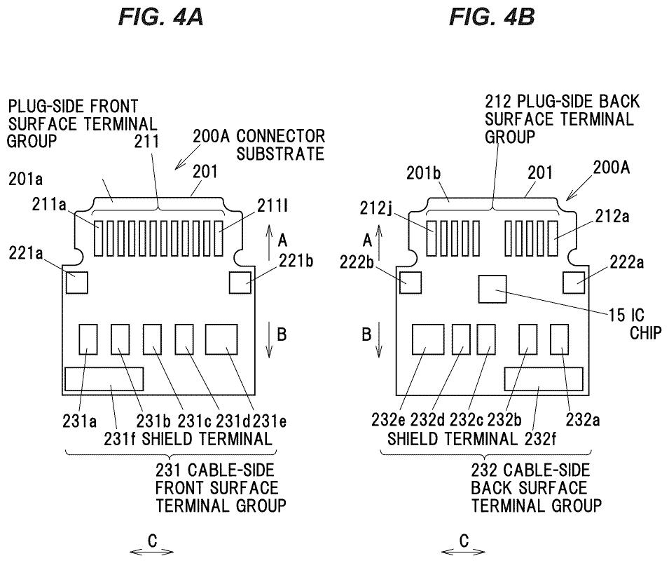

FIGS. 3A and 3B show a connector substrate 200B compatible with a cable compliant with the USB Type-C standard, wherein FIG. 3A is a plan view when the connector substrate 200B is viewed from the front side, and FIG. 3B is a plan view when the connector substrate 200B is viewed from the back side. FIGS. 4A and 4B show an example of the connector substrate 200A in the first embodiment, wherein FIG. 4A is a plan view when the connector substrate 200A is viewed from the front side, and FIG. 4B is a plan view when the connector substrate 200A is viewed from the back side. In FIGS. 3A, 3B, 4A and 4B, A indicates the plug side, B indicates the cable side, and C indicates a width direction of the connector substrate.
Configuration of Connector Substrate that is Compatible with Cable Compliant with USB Type-C Standard
The connector substrate 200B, which is compatible with cables compatible with the USB Type-C standard, is configured to be compatible with an 18-core cable, i.e., has 18 terminals (also called pads), and has a base 201 made of an insulating material, as shown in FIGS. 3A and 3B.

As shown in FIG. 3A, a plug-side front terminal group 211 composed of terminals 211a to 211l provided on the plug side A, terminals 221a and 221b provided in the middle between the plug side A and the cable side B, and a cable-side front terminal group 231 composed of terminals 231a to 231i provided on the cable side B are formed on a front surface 201a of the base 201.

As shown in FIG. 3B, a plug-side back terminal group 212 composed of terminals 212a to 212j provided on the plug side A, terminals 222a and 222b provided in the middle between the plug side A and the cable side B, and a cable-side back terminal group 232 composed of terminals 232a to 232i provided on the cable side B are formed on a back surface 201b of the base 201.

The terminals 231a to 231i of the cable-side front terminal group 231 are formed at a pitch of 0.9 to 1.0 mm, and the terminals 232a to 232i of the cable-side back terminal group 232 are formed at a pitch of 0.9 to 1.0 mm. That is, the minimum pitch of the terminals in the width direction C of the connector substrate 200B is 0.9 mm.

### Configuration of Connector Substrate in the First Embodiment

The connector substrate 200A in the first embodiment is a substrate compliant with the USB Type-C standard, but is configured to be compatible with a 10-core cable, i.e., to have 10 terminals (also called pads), and has the base 201 made of an insulating material, as shown in FIGS. 4A and 4B. In this regard, the number of terminals on the connector substrate 200A may be increased or decreased according to the number of cores in the communication cable 1.

As shown in FIG. 4A, a plug-side front terminal group 211 composed of terminals 211a to 2111 provided on the plug side A, terminals 221a and 221b for a metal cover (not shown) of the plug 112A which are provided in the middle between the plug side A and the cable side B, and a cable-side front terminal group 231 composed of terminals 231a to 231f provided on the cable side B are formed on the front surface 201a of the base 201. In the cable-side front terminal group 231, the terminal 231f is a shield terminal and has a rectangular shape with its longitudinal direction coincident with the width direction C of the connector substrate 200A. The terminals 231a and 231b in the cable-side front terminal group 231 are an example of a pair of front terminals. The shield terminal 231f is an example of a front shield terminal.

As shown in FIG. 4B, a plug-side back terminal group 212 composed of terminals 212a to 212j provided on the plug side A, terminals 222a and 222b for a metal cover (not shown) of the plug 112A which are provided in the middle between the plug side A and the cable side B, and a cable-side back terminal group 232 composed of terminals 232a to 232f provided on the cable side B are formed on the back surface 201b of the base 201. In the cable-side back terminal group 232, the terminal 232f is a shield terminal and has a rectangular shape with its longitudinal direction coincident with the width direction C of the connector substrate 200A. In addition, an IC chip (also called eMarker) 15 that performs control related to power supply is mounted on the back surface 201b of the base 201 of one of the pair of connector substrates 200A. The IC chip 15 may alternatively be mounted on the front surface 201a of the base 201. In addition, the pair of connector substrates 200A may not include the IC chip 15, depending on the specifications of the device to be connected. The front surface 201a and the back surface 201b are examples of one of surfaces. The terminals 232a, 232b in the cable-side back terminal group 232 are an example of a pair of back terminals. The shield terminal 232f is an example of a back shield terminal. The IC chip (eMarker) 15 is an example of the circuit element arranged in a plug.

Specification information such as manufacturer information (Vender ID) or current carrying capacity (Max Voltage, Max Current), etc. are recorded in the IC chip 15. The USB PD 3.1 standard allows power delivery up to 240 W (48 V, 5 A), and the USB PD 3.0 standard allows power delivery up to 100 W (20 V, 5 A) when supporting 5 A current and up to 60 W (20 V, 3 A) when supporting 3 A current. In the IC chip 15 of the first embodiment, e.g., voltages of 5V, 9V, 15V, and 20V and a current of 3 A are recorded as the power rules for power which can be output, and e.g., a maximum voltage of 20V and a maximum current of 3 A are recorded as current carrying capacity. The communication cable assembly 100 includes the IC chip 15. Therefore, even if the second device requests an output (e.g., 100 W) that is more than the power that the first device can output (e.g., 60 W), the PD control unit of the first device supplies power close to the output request (20 V, 3 A) to the second device through the communication cable 1 based on the power rules for power which can be output.

The terminals 231a to 231e in the cable-side front terminal group 231, excluding the shield terminal 231f, are formed at a pitch of 1.0 to 1.57 mm, while the terminals 232a to 232e in the cable-side back terminal group 232, excluding the shield terminal 232f, are formed at a pitch of 1.2 to 2.0 mm. That is, the minimum pitch of the terminals in the width direction C of the connector substrate 200A is 1.2 mm.

According to the connector substrate 200A of the first embodiment, the minimum pitch of the terminals in the width direction C can be increased to not less than 1.3 times that of the connector substrate 200B that is compliant with the USB Type-C standard. In addition, since the number of cores in the cable is reduced, the number of pads on the connector substrate 200A can also be reduced, and the pad width can be increased, e.g., from 0.5 mm to 0.8 mm for the same dimension and area as the connector substrate 200B that is compliant with the USB Type-C standard. The above configuration allows the connection work to be performed with naked eyes. In addition, the work of connecting the communication cable 1 to the connector substrate 200A can be performed without using a tool (wire alignment component) that aligns and holds an end of the communication cable 1 to be connected.

### Method for Manufacturing Communication Cable Assembly

Next, an example of a method for manufacturing the communication cable assembly 100 in the first embodiment will be described.

First, the two first differential pairs 2A, 2B, the second differential pair 3, the power wire 4, the ground wire 5, the CC wire 6, the Vconn wire 8 and the filler string 13 are prepared. The inner shielding layer 11a is formed by wrapping a conductive tape around the two signal wires 2a, 2b, or two signal wires 2c, 2d, and the drain wire 10 while twisting these wires, and the outer shielding layer 11b is then formed by wrapping a resin tape around the inner shielding layer 11a, thereby forming each of the first differential pairs 2A and 2B. The second differential pair 3 is formed by twisting the two signal wires 3a and 3b together.

Next, the two first differential pairs 2A, 2B, the second differential pair 3, the power wire 4, the ground wire 5, the CC wire 6, the Vconn wire 8, and the filler string 13, which have been prepared, are twisted together, the inner shielding layer 12a is formed by wrapping a conductive tape therearound, and the outer shielding layer 12b is then formed by wrapping a metal braid around the inner shielding layer 12a. Next, the sheath 7 is formed around the shielding layer 12 by extrusion using an extruder.

The communication cable 1 is manufactured through the above process. After that, the communication cable 1 is cut to the required length, and its terminal ends are connected to the connector substrate 200A of the first connector 110A and the connector substrate 200A of the second connector 110B, thereby manufacturing the communication cable assembly 100 that includes the first connector 110A and the second connector 110B at both ends of the communication cable 1. The connection work to connect the first differential pairs 2A, 2B to the connector substrate 200A will be described below.

### Connection Work of First Differential Pairs

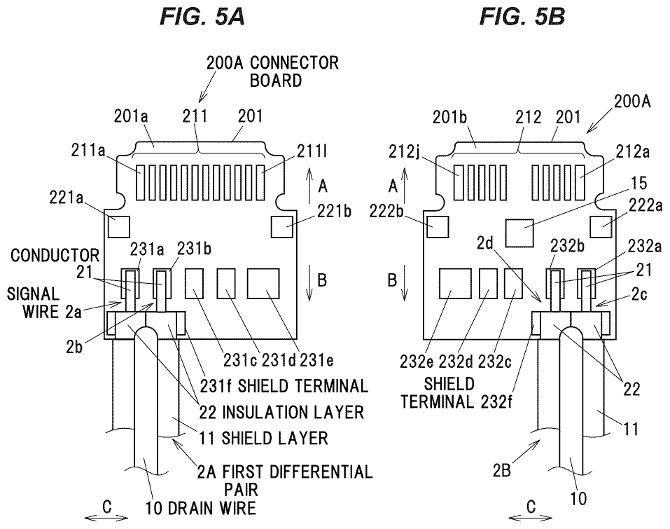

FIGS. 5A and 5B are explanatory diagrams illustrating how the signal wires 2a to 2d of the first differential pairs 2A, 2B in the first embodiment are connected to the connector substrate 200A shown in FIGS. 4A and 4B, wherein FIG. 5A is a plan view when the connector substrate 200A is viewed from the front side, and FIG. 5B is a plan view when the connector substrate 200A is viewed from the back side.

The conductors 21 of the signal wires 2a, 2b constituting the first differential pair 2A are connected to the terminals 231a and 231b shown in FIG. 5A. The conductors 21 of the signal wires 2c, 2d constituting the first differential pair 2B are connected to the terminals 232a and 232b shown in FIG. 5B. Here, when connecting the conductors 21 of the signal wires 2a, 2b constituting the first differential pair 2A to the terminals 231a, 231b in the cable-side front terminal group 231 on the connector substrate 200B shown in FIG. 3A which is compatible with cables compliant with the USB Type-C standard, it is necessary to strip the shielding layers 11, further strip the insulation layers 22 of the signal wires 2a, 2b, and then connect the exposed conductors 21 to the narrow-pitched terminals 231a, 231b. On the other hand, when connecting the conductors 21 of the signal wires 2a, 2b constituting the first differential pair 2A to the terminals 231a, 231b in the cable-side front terminal group 231 on the connector substrate 200A shown in FIG. 4A, connection work of the signal wires 2a, 2b can be easily performed since the pitch of the terminals 231a, 231b is wide. The same applies to the back surface 201b of the connector substrate 200A shown in FIG. 4B. The drain wire 10 is led out of the shielding layer 11 and is connected to the metal cover (not shown) of the plug 112A.

The conductors 31 of the signal wires 3a, 3b constituting the second differential pair 3 are connected to, e.g., the terminals 231c and 231d shown in FIG. 5A, and the conductor 51 of the ground wire 5 is connected to, e.g., the terminal 231e shown in FIG. 5A. The power wire 4 is connected to, e.g., the terminal 232e shown in FIG. 5B, the conductor 61 of the CC wire 6 is connected to, e.g., the terminal 232c shown in FIG. 5B, and the Vconn wire 8 is connected to, e.g., the terminal 232d shown in FIG. 5B. The CC wire 6 and the Vconn wire 8 are connected to the IC chip (eMarker) 15 through a wiring pattern (not sown).

### Effects of the First Embodiment

The communication cable assembly 100 in the first embodiment exerts the following effects.
(a) The number of cores can be reduced compared to the core configuration of cables compliant with the USB Type-C standard, which reduces manufacturing costs and also reduces the weight.
(b) The outer diameter of the cores can be large for the same cable outer diameter, which improves various characteristics (communication performance, bending resistance (which refers to the property of being less likely to break when repeatedly bent; the same applies hereinafter), and mechanical strength). In addition, having thicker conductors reduces the risk of wire breakage due to injection pressure during molding, resulting in more choice of molding methods. In addition, the thickness of cores such as the signal wires 2a, 2b can be large for the same cable outer diameter, hence, the selection of materials for the insulation layer is expanded and it is thereby possible to, e.g., change the selection of constituent materials from an expensive nylon-based resin such as polyamide to an inexpensive polyolefin-based resin such as polyethylene, and also to shorten the molding time by changing the molding machine from a dedicated molding machine that performs low-pressure molding to a general-purpose molding machine that performs injection molding.
(c) Reducing the number of first differential pairs transmitting high-speed differential signals to two allows the conductors 21 of the signal wires 2a to 2d to be thicker, hence, the communication distance of the high-speed differential signals can be increased relative to the cable diameter. That is, when the cable diameter is reduced (e.g., to 3.7 mm), the weight of the communication cable can be reduced without shortening the communication distance. In addition, when the cable diameter is about the same as conventional cables (e.g., 6.8 mm), the communication distance can be longer.
(d) Since the CC wire 6 and the Vconn wire 8 are included, high-speed device charging with power compliant with the USB PD standard is possible between a recharger and a device which are connected through the communication cable 1. In addition, since reducing the number of first differential pairs transmitting high-speed differential signals to two allows the conductor 41 of the power wire 4 and the conductor 51 of the ground wire 5 to be thicker, the power supply distance can be increased (e.g., to about the same as the communication distance).
(e) Having the CC wire 6 allows for the use of a reversible plug that can be inserted into a receptacle even when the front and back (top and bottom) are reversed.
(f) Since the pitch of the terminals 231a, 231b and the pitch of the terminals 232a, 232b on the connector substrate 200A are wide, the signal wires 2a to 2d constituting the first differential pair 2A, 2B can be easily connected to the connector substrate 200A.

### Second Embodiment

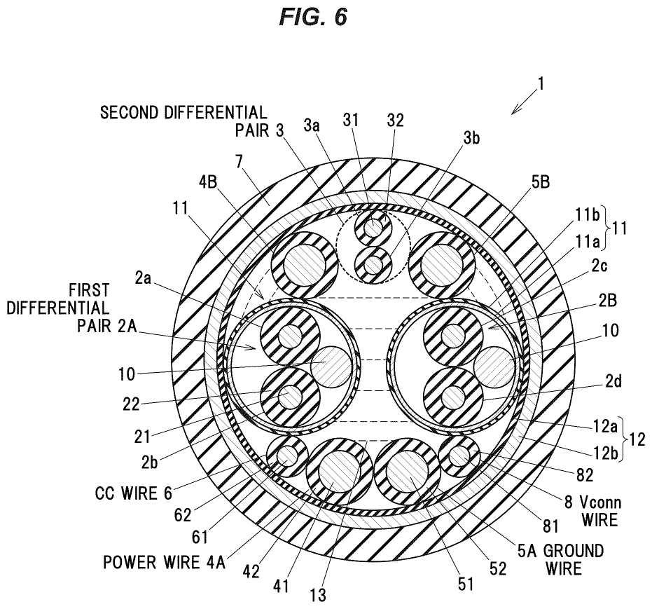

FIG. 6 is a cross-sectional view showing an example of the communication cable in the second embodiment of the invention. The communication cable 1 in the first embodiment uses one power wire 4 and one ground wire 5, but the communication cable 1 in the second embodiment uses plural (e.g., two) power wires 4 and ground wires 5. Next, the second embodiment will be described, with a focus on differences from the first embodiment. In addition, since the communication cable assembly 100 in the second embodiment is manufactured in the same manner as the first embodiment, the explanation thereof will be omitted.

The communication cable 1 in the second embodiment is a 12-core cable which includes the two first differential pairs 2A, 2B, the second differential pair 3, the CC wire 6 and the Vconn wire 8 in the same manner as the first embodiment, and further includes a pair of power wires 4A, 4B and a pair of ground wires 5A, 5B. The pair of power wires 4A, 4B and the pair of ground wires 5A, 5B are arranged in a distributed manner. In this regard, the number of power wires is not limited to two, and may be three or more. Likewise, the number of ground wires is not limited to two, and may be three or more.

The conductors 41 of the power wires 4A, 4B and the conductors 51 of the ground wires 5A, 5B have a cross-sectional area such that, e.g., the power supply distance, with which the voltage drop when supplying power of 60 W (20 V, 3 A) is not more than 500 mV in the power wire 4 and not more the 250 mV in the ground wire 5, is at least not less than 3.0 m, preferably not less than 5.0 m, and more preferably not less than 6.0 m, in the same manner as the first embodiment. In particular, each of the total cross-sectional area of the conductors 41 of the power wires 4A, 4B and the total cross-sectional area of the conductors 51 of the ground wires 5A, 5B is preferably not less than 0.30 mm², and more preferably not less than 0.50 mm². In addition, each of the total cross-sectional area of the conductors 41 of the power wires 4A, 4B and the total cross-sectional area of the conductors 51 of the ground wires 5A, 5B is preferably not more than 1.5 mm², and more preferably not more than 1.0 mm² so that the connection work to the connector substrate 200A is not difficult. Due to the size limitation of the connector substrate 200A for the fitting portion compliant with the USB Type-C standard, a ratio of the conductor diameter of the conductors 41 of the power wires 4A, 4B and the conductor diameter of the conductors 51 of the ground wires 5A, 5B (note: each of which is a conductor diameter converted so as to be equivalent to that of a single wire so that the resistance value is the same) to the cable diameter is preferably not less than 0.10 and mot more than 0.23.

In the second embodiment, since the pair of power wires 4A, 4B and the pair of ground wires 5A, 5B can have thicker conductors 41 and 51 than when the power wire 4 and the ground wire 5 are used respectively alone, the power supply distance can be increased to a similar level to that in the first embodiment. In addition, arranging the pair of power wires 4A, 4B and the pair of ground wires 5A, 5B in a distributed manner stabilizes the cable structure, thereby keeping the cross-sectional shape of the entire communication cable 1 circular.

### Third Embodiment

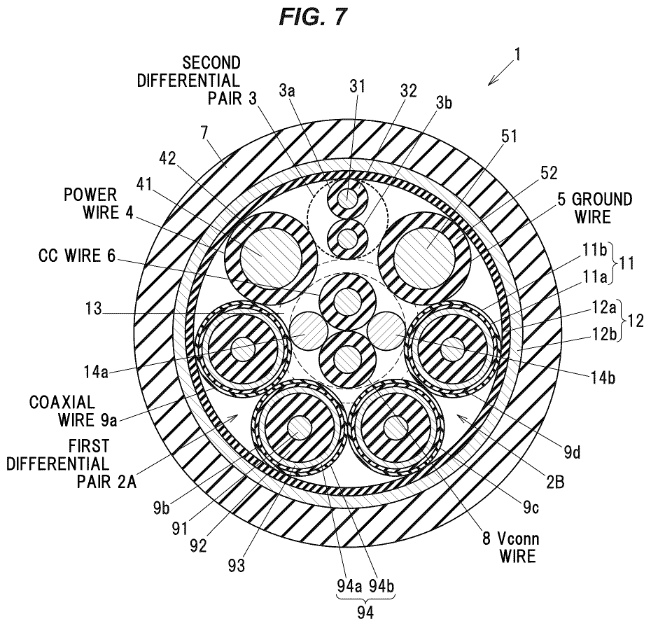

FIG. 7 is a cross-sectional view showing an example of the communication cable in the third embodiment of the invention. In the communication cable 1 of the first embodiment, the first pair of differential wires, which are the signal wires 2a, 2b, and the second pair of differential wires, which are the signal wires 2c, 2d, constitute the two first differential pairs A and 2B, and each pair is shielded by the shielding layer 11. In contrast, coaxial wires 9a to 9d are used as signal wires constituting the two first differential pairs 2A, 2B in the communication cable 1 of the third embodiment (also called a coaxial-type communication cable). Next, the third embodiment will be described, with a focus on differences from the first embodiment.

In the communication cable 1 of the third embodiment, the first differential pair 2A is composed of the first pair of differential wires which is a pair of coaxial wires 9a, 9b, the first differential pair 2B is composed of the second pair of differential wires which is a pair of coaxial wires 9c, 9d, the coaxial wires 9a to 9d are arranged on the outer circumference side, the CC wire 6 and filler strings 14a, 14b are arranged at the center, and the first differential pair 2A, 2B, the second differential pair 3, the power wire 4 and the ground wire 5, together with the filler string 13, are covered with the shielding layer 12 which is in turn covered with the sheath 7. The filler strings 14a, 14b are made of a resin material (e.g., polyethylene). The coaxial wires 9a to 9d are an example of the signal wires constituting the first differential pair. The filler strings 14a, 14b are an example of the filler.

Each of the coaxial wires 9a to 9d includes a center conductor 91, an inner insulation layer 92 that covers the center conductor 91, an outer conductor 93 formed on the outer side of the inner insulation layer 92, and an outer insulation layer 94 that covers the outer conductor 93. The center conductor 91 is, e.g., a stranded wire formed by twisting plural metal strands together. The inner insulation layer 92 is made of a resin material (e.g., cross-linked polyethylene). The outer conductor 93 is formed of, e.g., a metal braid, etc. The outer insulation layer 94 includes a first outer insulation layer 94a made of a resin material (e.g., polyvinyl chloride), and a second outer insulation layer 94b provided on the outer side of the first outer insulation layer 94a and made of a resin material (e.g., polyvinyl chloride). The center conductor 91 is an example of the conductor at the center.

The center conductors 91 of the coaxial wires 9a to 9d constituting the first differential pairs 2A, 2B have a cross-sectional area that, e.g., allows communication over a distance of at least not less than 4.0 m, preferably not less than 5.0 m, and more preferably not less than 6.0 m at a transfer rate of 5 Gbps, in the same manner as the first embodiment. In particular, the cross-sectional area of the center conductors 91 of the coaxial wires 9a to 9d is preferably not less than 0.06 mm², and more preferably not less than 0.08 mm². The cross-sectional area of the center conductors 91 of the coaxial wires 9a to 9d is preferably also not more than 0.35 mm², more preferably not more than 0.23 mm² so that connection work to the connector substrate 200A is not difficult. Due to the size limitation of the connector substrate 200A for the fitting portion compliant with the USB Type-C standard, a ratio of the conductor diameter of the center conductors 91 of the coaxial wires 9a to 9d to the cable diameter is preferably not less than 0.06.

### Method for Manufacturing Communication Cable Assembly

Next, an example of the method for manufacturing the communication cable assembly 100 in the third embodiment will be described.

First, the two first differential pairs 2A, 2B, the second differential pair 3, the power wire 4, the ground wire 5, the CC wire 6, the Vconn wire 8 and the filler strings 13, 14a, 14b are prepared. For the first differential pairs 2A, 2B, four coaxial wires 9a to 9d which constitute them are prepared. The second differential pair 3 is formed by twisting the two signal wires 3a and 3b together.

Next, the two first differential pairs 2A, 2B, the second differential pair 3, the power wire 4, the ground wire 5, the CC wire 6, the Vconn wire 8, and the filler strings 13, 14a, 14b, which have been prepared, are twisted together, the inner shielding layer 12a is formed by wrapping a conductive tape therearound, and the outer shielding layer 12b is then formed by wrapping a metal braid around the inner shielding layer 12a. Next, the sheath 7 is formed around the shielding layer 12 by extrusion using an extruder.

The communication cable 1 is manufactured through the above process. After that, the communication cable 1 is cut to the required length, and its terminal ends are connected to the connector substrate 200A of the first connector 110A and the connector substrate 200A of the second connector 110B, thereby manufacturing the communication cable assembly 100 that includes the first connector 110A and the second connector 110B at both ends of the communication cable 1. The connection work to connect the coaxial wires 9a to 9d constituting the first differential pairs 2A, 2B to the connector substrate 200A will be described below.

### Connection Work of First Differential Pairs

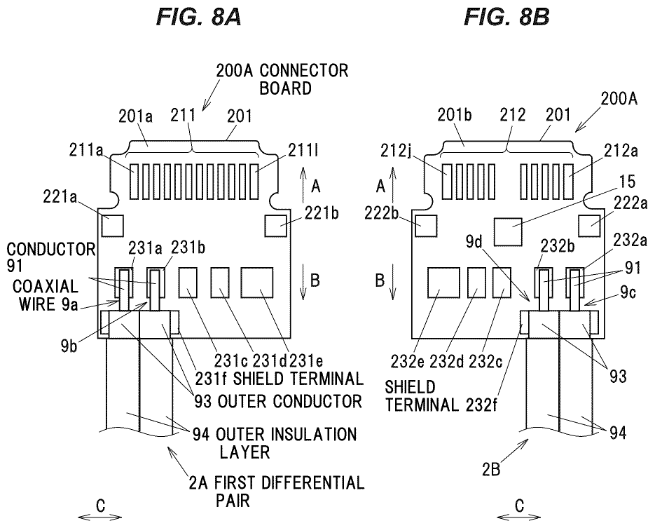

FIGS. 8A and 8B are explanatory diagrams illustrating how the first differential pair in the third embodiment is connected to the connector substrate shown in FIGS. 4A and 4B, wherein FIG. 8A is a plan view when the connector substrate is viewed from the front side, and FIG. 8B is a plan view when the connector substrate is viewed from the back side.

When connecting the center conductors 91 of the coaxial wires 9a, 9b of the communication cable 1 in the third embodiment to the terminals 231a, 231b in the cable-side front terminal group 231 on the connector substrate 200B shown in FIG. 3A which is compatible with cables compliant with the USB Type-C standard, it is necessary to strip the outer insulation layers 94, further strip the inner insulation layers 92 of the coaxial wires 9a, 9b, and then connect the exposed center conductors 91 to the narrow-pitched terminals 231a, 231b. In addition, each outer conductor 93 needs to be pulled and drawn into a single conductor wire shape and connected to a shield terminal (the metal cover (not shown) of the plug 112A). On the other hand, when connecting the center conductors 91 of the coaxial wires 9a, 9b to the terminals 231a, 231b in the cable-side front terminal group 231 on the connector substrate 200A shown in FIG. 4A, connection work of the coaxial wires 9a, 9b can be easily performed since the pitch of the terminals 231a, 231b is wide. In addition, without pulling and drawing the exposed outer conductors 93 into a single conductor wire shape, the outer surfaces thereof can be connected to the shield terminal 231f. The same applies to the back surface 201b of the connector substrate 200A shown in FIG. 4B.

### Effects of the Third Embodiment

The communication cable assembly 100 in the third embodiment exerts the same effects as those in the first embodiment and also exerts the following effects.
(a) Reducing the number of first differential pairs transmitting high-speed differential signals to two allows the center conductors 91 of the coaxial wires 9a to 9d to be thicker, hence, the communication distance of the high-speed differential signals can be increased relative to the cable diameter.
(b) Since the conductor 41 of the power wire 4 and the conductor 51 of the ground wire 5 can be increased in thickness, the power supply distance can be increased (e.g., to about the same as the communication distance).
(c) Since the coaxial wires 9a to 9d are used as the signal wires constituting the first differential pairs 2A and 2B, the outer surfaces of the outer conductors 93 exposed by stripping the outer insulation layers 94 of the coaxial wires 9a to 9d can be connected to the shield terminals 231f and 232f, which facilitates the connection work to connect the coaxial wires 9a to 9d to the connector substrate 200A.
(d) Since the coaxial wires 9a to 9d are used as the first differential pairs 2A, 2B, change in differential characteristics is very little due to the coaxial wires 9a to 9d being independent of each other, hence, bending resistance can be improved compared to Twinax-type communication cables.

### Modified Example 1

The communication cable 1 in each of the above embodiments includes the second differential pair 3 that transmits low-speed differential signals, but the second differential pair 3 may be omitted from the communication cable 1. This allows the conductors of the signal wires constituting the first differential pairs 2A, 2B to be even thicker and the communication distance of high-speed differential signals to be further increased. The conductor diameters of the power and ground wires can also be further increased, making it possible to further increase the power supply distance.

### Modified Example 2

In each of the above embodiments, the communication cable 1 includes the Vconn wire 8 and the IC chip 15 is mounted on the connector substrate 200A. However, the Vconn wire 8 and the IC chip 15 may be omitted depending on the specifications of the device to be connected.

### Modified Example 3

In each of the above embodiments, the communication cable 1 includes the Vconn wire 8 and the IC chip 15 is mounted on the connector substrate 200A. However, the IC chip 15 may be omitted without omitting the Vconn wire. This allows for cost reduction.

### Modified Example 4

The communication cable 1 in each of the above embodiments includes the second differential pair 3 that transmits low-speed differential signals, but the communication cable 1 may be a 7-core cable in which the second differential pair 3 is omitted and the Vconn wire 8 is further omitted along with the omission of the IC chip 15. This allows the conductors of the signal wires constituting the first differential pairs 2A, 2B to be even thicker and the communication distance of high-speed differential signals to be further increased. The conductor diameters of the power and ground wires can also be further increased, making it possible to further increase the power supply distance.

### Modified Example 5

In each of the above embodiments, the communication cable 1 includes the ground wire 5. However, the ground wire 5 may be omitted from the communication cable 1, where a drain wire, etc. may be added in place of the ground wire 5, or the number of strands of the overall shield may be increased so as to substitute for the ground wire 5. This allows the cable diameter to be reduced. The drain wire and the strands of the overall shield are examples of the wire material that serves as a ground wire.

### Examples

Communication performance (the communication distance) and power supply performance (the power supply distance) were tested and evaluated for Example 1 corresponding to the first embodiment, Example 2 corresponding to the second embodiment, Example 3 partially corresponding to the first embodiment, and Comparative Examples 1 and 2. The configurations of the tested communication cables in Examples 1, 2, and 3 are shown in Table 1, and the configurations of the tested communication cables in Comparative Examples 1 and 2 are shown in Table 2. In Tables 1 and 2, T indicates tin-plated soft copper wire and AG indicates silver-plated soft copper wire.

TABLE 1

| | | | | Example 1 | Example 2 | Example 3 |
|---|---|---|---|---|---|---|
| First | Signal | Conductor | AWG size · Outer | 27 · 0.42 | Same as | Same as |
| differential | wire | | diameter (mm) | | on the left | on the left |
| pair | | | Strand configuration | 7/0.14T | Same as | Same as |
| | | | (Number of strands/mm) | | on the left | on the left |
| | | Insulation | Material | Crosslinked | Same as | Same as |
| | | layer | | PE | on the left | on the left |
| | | | Outer diameter (mm) | 1.12 | Same as | Same as |
| | | | | | on the left | on the left |
| | Drain | Strand configuration (Number of | | 7/0.14T | Same as | Same as |
| | wire | strands/mm) | | | on the left | on the left |
| | | Outer diameter (mm) | | 0.42 | Same as | Same as |
| | | | | | on the left | on the left |
| | Shielding | Inner layer | Material (Tape) | Polyester/ | Same as | Same as |
| | layer | | | Copper | on the left | on the left |
| | | | Outer diameter (mm) | 2.3 | Same as | Same as |
| | | | | | on the left | on the left |
| | | Outer layer | Material (Tape) | Polyester | Same as | Same as |
| | | | | | on the left | on the left |
| | | | Outer diameter (mm) | 2.34 | Same as | Same as |
| | | | | | on the left | on the left |
| Second | Signal | Conductor | AWG size · Outer | 28 · 0.38 | Same as | Same as |
| differential | wire | | diameter (mm) | | on the left | on the left |
| pair | | | Strand configuration | 7/0.127T | Same as | Same as |
| | | | (Number of strands/mm) | | on the left | on the left |
| | | Insulation | Material | PE | Same as | Same as |
| | | layer | | | on the left | on the left |
| | | | Outer diameter (mm) | 0.75 | Same as | Same as |
| | | | | | on the left | on the left |

| Power wire · Ground | Number of wires | | 1 | 2 | 1 |
|---|---|---|---|---|---|
| wire | Conductor | AWG size · Outer | 18 · 1.19 | 22 · 0.80 | 22 · 0.76 |
| | | diameter (mm) | | | |
| | | Total cross-sectional area | 0.823 | 0.763 | 0.342 |
| | | (mm²) | | | |
| | | Conductor resistance | 23.8 | 25.7 | 57.6 |
| | | (Ω/km) | | | |
| | | Strand configuration | 41/0.16T | 19/0.16T | 17/0.16T |
| | | (Number of strands/mm) | | | |
| | Insulation | Material | ETFE | Same as | Non-lead |
| | layer | | | on the left | PVC |
| | | Outer diameter (mm) | 1.50 | 1.10 | 1.20 |
| CC wire · Vconn wire | Conductor | AWG size · Outer | 28 · 0.38 | Same as | Same as |
| | | diameter (mm) | | on the left | on the left |
| | | Strand configuration | 7/0.13T | Same as | Same as |
| | | (Number of strands/mm) | | on the left | on the left |
| | Insulation | Material | PVC | Same as | Non-lead |
| | layer | | | on the left | PVC |
| | | Outer diameter (mm) | 0.78 | Same as | 0.78 |
| | | | | on the left | |

| Shielding layer | Braid configuration (mm) | Single | Same as | Same as |
|---|---|---|---|---|
| | | layer · 0.1T | on the left | on the left |
| | Outer diameter (mm) | 5.05 | 5.35 | 5.05 |
| Sheath | Material | PVC | Same as | Non-lead |
| | | | on the left | PVC |
| | Thickness (mm) · Outer | 0.875 · 6.8 | 0.725 · 6.8 | 0.875 · 6.8 |
| | diameter (mm) | | | |

| | | | |
|---|---|---|---|
| Communication distance (m) (Transfer rate 5 Gbps) | 6.0 | 6.0 | 6.0 |
| Power supply distance (m) (Conditions: Voltage 20 V, Current 3 A) | 7.0 | 6.0 | 3.0 |

TABLE 2

| | | | | Comparative | Comparative |
|---|---|---|---|---|---|
| | | | | Example 1 | Example 2 |
| First | Signal | Conductor | AWG size · Outer | 32/0.24 | 30 · 0.30 |
| differential | wire | | diameter (mm) | | |
| pair | | | Strand configuration | 7/0.08T | 7/0.102AG |
| (Two pairs | | | (Number of strands/mm) | | |
| in | | Insulation | Material | Crosslinked PE | PFA |
| Comparative | | layer | Outer diameter (mm) | 0.60 | 0.75 |
| Example | Drain | Strand configuration (Number of | | 7/0.08T | 7/0.102T |
| 1, Four | wire | strands/mm) | | | |
| pairs in | | Outer diameter (mm) | | 0.24 | 0.30 |
| Comparative | Shielding | Inner layer | Material (Tape) | Polyester/ | Polyester/ |
| Example | layer | | | Copper | Alminum |
| 2) | | | Outer diameter (mm) | 2.3 | 1.56 |
| | | Outer layer | Material (Tape) | Polyester | Same as on the |
| | | | | | left |
| | | | Outer diameter (mm) | 2.34 | 1.60 |
| Second | Signal | Conductor | AWG size · Outer | 34 · 0.19 | Same as on the |
| differential | wire | | diameter (mm) | | left |
| pair | | | Strand configuration | 7/0.064T | Same as on the |
| | | | (Number of strands/mm) | | left |
| | | Insulation | Material | PFA | Same as on the |
| | | layer | | | left |
| | | | Outer diameter (mm) | 0.34 | 0.40 |

| Power wire · Ground | Number of wires | | 1 | 1 |
|---|---|---|---|---|
| wire | Conductor | AWG size · Outer | 26 · 0.48 | 26/0.50 |
| | | diameter (mm) | | |
| | | Total cross-sectional area | 0.140 | 0.150 |
| | | (mm²) | | |
| | | Conductor resistance | 134 | 132 |
| | | (Ω/km) | | |
| | | Strand configuration | 7/0.16T | 19/0.1T |
| | | (Number of strands/mm) | | |
| | Insulation | Material | Crosslinked PE | Same as on the |
| | layer | | | left |
| | | Outer diameter (mm) | 0.75 | Same as on the |
| | | | | left |
| CC wire · Vconn wire | Conductor | AWG size · Outer | 34 · 0.192 | 34 · 0.19 |
| (Only CC wire in | | diameter (mm) | | |
| Comparative example 2) | | Strand configuration | 7/0.064T | Same as on the |
| | | (Number of strands/mm) | | left |
| | Insulation | Material | PFA | Crosslinked PE |
| | layer | Outer diameter (mm) | 0.34 | 0.41 |

| Shielding layer | Braid configuration (mm) | Single layer · | Single layer · |
|---|---|---|---|
| | | 0.08T | 0.05T |
| | Outer diameter (mm) | 2.56 | 4.18 |
| Sheath | Material | Non-lead PVC | Same as on the |
| | | | left |
| | Thickness (mm) · Outer | 0.57 · 3.7 | 0.51 · 5.2 |
| | diameter (mm) | | |

| | | |
|---|---|---|
| Communication distance (m) (Transfer rate 5 Gbps) | 3.5 | 3.0 |
| Power supply distance (m) (Conditions: Voltage 20 V, Current 3 A) | — | 2.0 |

Example 1 corresponds to the first embodiment, where 27 AWG wires (conductor diameter 0.42 mm) are used as the conductors 21 of the signal wires 2a to 2d constituting the first differential pairs 2A and 2B, and 18 AWG wires (conductor diameter 1.19 mm, cross-sectional area 0.823 m², conductor resistance 23.8 Ω/km) are used as the conductors 41 and 51 of the power wire 4 and the ground wire 5. The conductor resistance was calculated using a resistivity of 0.0196 Ω·mm² per unit area (the same applies hereinafter). Regarding the first differential pairs 2A and 2B, the ratio of the conductor diameter d to the cable diameter D (d/D) was 0.062

Example 2 corresponds to the second embodiment, where 27 AWG wires (conductor diameter 0.42 mm) are used as the conductors 21 of the signal wires 2a to 2d constituting the first differential pairs 2A and 2B in the same manner as Example 1, and 22 AWG wires (conductor diameter 0.80 mm, total cross-sectional area 0.763 m², conductor resistance 25.7 Ω/km) are used as the conductors 41 and 51 of the power wires 4A, 4B and the ground wires 5A, 5B. Regarding the first differential pairs 2A and 2B, the ratio of the conductor diameter d to the cable diameter D (d/D) was 0.062.

Example 3 is the same as Example 1, except that 22 AWG wires (conductor diameter 0.76 mm, cross-sectional area 0.342 m², conductor resistance 57.5 Ω/km), which are thinner than in Example 1, are used as the conductors 41 and 51 of the power wire 4 and the ground wire 5. Regarding the first differential pairs 2A and 2B, the ratio of the conductor diameter d to the cable diameter D (d/D) was 0.062.

In Comparative Example 1, 32 AWG wires (conductor diameter 0.24 mm), which are thinner than in Example 1, are used as the conductors 21 of the signal wires 2a to 2d constituting the first differential pairs 2A and 2B, and 26 AWG wires (conductor diameter 0.48 mm, cross-sectional area 0.140 m², conductor resistance 134 Ω/km), which are thinner than in Example 1, are used as the conductors 41 and 51 of the power wire 4 and the ground wire 5. Regarding the first differential pairs 2A and 2B, the ratio of the conductor diameter d to the cable diameter D (d/D) was 0.065.

Comparative Example 2 is a 17-core cable using four first differential pairs and having a diameter of 5.2 mm, where 30 AWG wires (conductor diameter 0.30 mm), which are thinner than in Example 1, are used as the conductors 21 of the signal wires 2a to 2d constituting the first differential pairs, and 26 AWG wires (conductor diameter 0.50 mm, cross-sectional area 0.150 m², conductor resistance 132 Ω/km), which are thinner than in Example 1, are used as the conductors 41 and 51 of the power wire 4 and the ground wire 5. Regarding the first differential pairs 2A and 2B, the ratio of the conductor diameter d to the cable diameter D (d/D) was 0.058. When this ratio (d/D) is more than 0.08, the weight of the communication cable increases. Therefore, to suppress the increase in weight of the communication cable, the ratio (d/D) regarding the first differential pair 2A, 2B is preferably not less than 0.06 and no more than 0.08, based on Examples 1, 2, and 3 and Comparative Examples 1 and 2.

### Method of Evaluating Communication Distance

Video images captured by a camera were transmitted to a PC through the communication cables under test, and communication performance (the communication distance) was evaluated based on the presence or absence of image freeze, drop frame, noise, image discoloration, etc. during 10 minutes of imaging. The case where there was no problem with the video for 10 minutes was evaluated as ∘ (good), and the case where the video did not appear on the PC was evaluated as x (poor). The evaluation results are shown in Table 3.

### Attenuation Characteristics

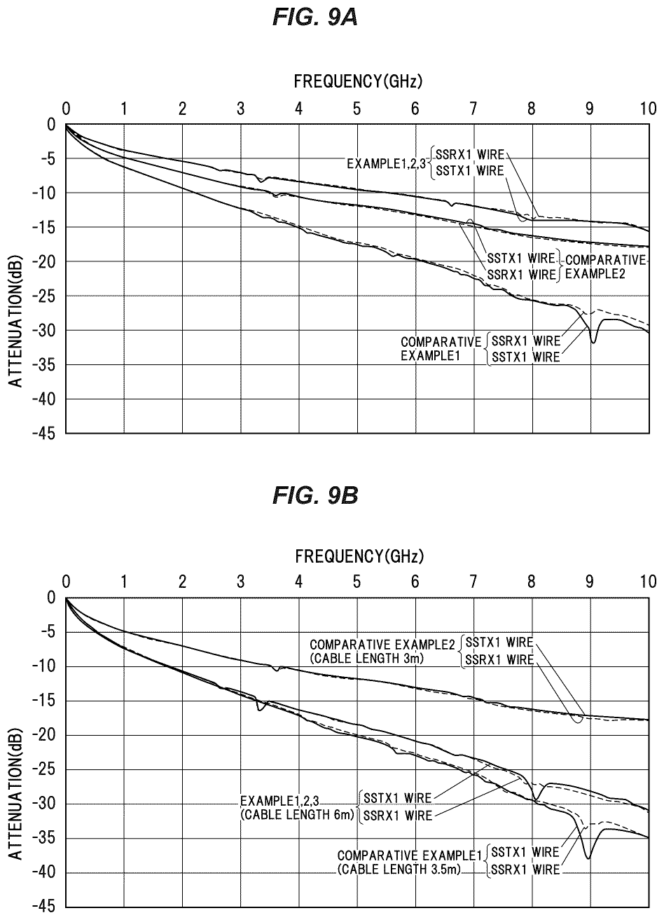

FIG. 9A is a diagram illustrating the attenuation characteristics when the cable length is 3 m. FIG. 9B is a diagram illustrating the attenuation characteristics for cable lengths (lengths of the cables used in the test) corresponding to the respective communication distances. The data transfer rate of the camera used was 5 Gbps, hence, the attenuation characteristics around 2.5 GHz were measured.

The amount of attenuation when the length of the communication cable is 3 m depends on the AWG size of the communication cable, and as shown in FIG. 9A, the amount of attenuation is smaller with the lower AWG size number (with the larger conductor diameter). That is, the amount of attenuation near a frequency of 2.5 GHz was 6 dB in Examples 1, 2, and 3, 11 dB in Comparative Example 1, and 8 dB in Comparative Example 2. These attenuation values are shown in Table 3.

As shown in FIG. 9B, the amount of attenuation in the cable having a length corresponding to the communication distance is 13 dB near a frequency of 2.5 GHz in Examples 1, 2, and 3 and Comparative Example 1, and this can be presumed as the communication limit. On the other hand, in Comparative Example 2, the amount of attenuation was as low as 8 dB near a frequency of 2.5 GHz but the communication distance was 3 m which is the shortest, and this is considered to be due to the power supply specifications through the power wire 4 (Vbus wire), the potential difference with GND, and other factors. The above attenuation values are shown in Table 3.

TABLE 3

| | | | | | Comparative | | | | Comparative | | | |
|---|---|---|---|---|---|---|---|---|---|---|---|---|
| | Examples 1, 2, 3 | | | | Example 1 | | | | Example 2 | | | |
| Conductor diameter d (mm) | 0.42 | | | | 0.24 | | | | 0.30 | | | |
| of First differential pair | | | | | | | | | | | | |
| Cable diameter D (mm) | 6.8 | | | | 3.7 | | | | 5.2 | | | |
| d/D | 0.062 | | | | 0.065 | | | | 0.058 | | | |
| Communication distance L | 5.0 | 5.5 | 6.0 | 6.5 | 2.5 | 3.0 | 3.5 | 4.0 | 2.0 | 2.5 | 3.0 | 3.5 |
| (m) | | | | | | | | | | | | |
| Evaluation of Video image | ∘ | ∘ | ∘ | x | ∘ | ∘ | ∘ | x | ∘ | ∘ | ∘ | x |

| | | | |
|---|---|---|---|
| L/D | 882 | 946 | 577 |
| Amount of attenuation (dB) | 6 (Cable | 11 (Cable | 8 (Cable |
| at near 2.5 GHz when cable | length 3 m) | length 3 m) | length 3 m) |
| length is 3 m | | | |
| Amount of attenuation (dB) | 13 (Cable | 13 (Cable | 8 (Cable |
| at near 2.5 GHz for cable | length 6 m) | length 3.5 m) | length 3 m) |
| length used | | | |

### Evaluation Results of Communication Distance

(1) As compared to Comparative Example 2 (cable diameter 5.2 mm), the communication distance was doubled in Examples 1, 2, and 3 (cable diameter 6.8 mm), from 3 m to 6 m. As compared to Comparative Example 2 (cable diameter 5.2 mm), Comparative Example 1 (cable diameter 3.7 mm) exhibited similar communication performance but achieved the weight reduction of the communication cable.
(2) When the cable diameter is D and the communication distance is L, the ratio of the communication distance L to the cable diameter D (L/D) as the evaluation value of the communication performance was L/D=6000 mm/6.8 mm=882 in Examples 1, 2, and 3, L/D=3500 mm/3.7 mm=946 in Comparative Example 1, and L/D=3000 mm/5.2 mm=577 in Comparative Example 2. Therefore, the communication distance to the cable diameter, L/D, is preferably not less than 800 or not less than 880, and more preferably not less than 900 or not less than 940.

### Method of Evaluating Power Supply Distance

The communication cables as test objects were subjected to a test for voltage drop (IR drop) caused by internal resistance, etc. of the power wire 4 when supplying a power of 60 W (20 V, 3 A). The device used for the test was a USB PD Tester (QuadraMAX). The judgment criteria were as follows: the test objects were deemed to pass the test when satisfying both the drop voltage of not more than 500 mV in the power wire and the drop voltage of not more than 250 mV in the ground wire, and were deemed to fail when not satisfying one or both criteria. The judgment results are shown in Tables 1 and 2.

### Evaluation Results of Power Supply Distance

In Example 1, the voltage drop was within the allowable range up to 7.0 m. In Example 2, the voltage drop was within the allowable range up to 6.0 m. In Example 3, the voltage drop was within the allowable range up to 3.0 m, but was greater than the allowable range at 4.0 m. Comparative Example 1 was not subject to evaluation because it cannot support PD communication due to its 9-core structure. In Comparative Example 2, the voltage drop was within the allowable range up to 2.0 m, but was greater than the allowable range at 3.0 m.

### Comprehensive Evaluation

Examples 1, 2 and 3 achieved the communication distance of 6.0 m for the cable diameter of 6.8 mm. Examples 1 and 2 achieved the power supply distance of not less than 6.0 m for the cable diameter of 6.8 mm. Thus, Examples 1 and 2 achieved both the communication distance of 6.0 m and the power supply distance of 6.0 m.

Although the embodiments of the invention have been described, embodiments of the invention are not to be limited to the embodiments described above, and various modifications can be implemented.

1. A communication cable with both terminal ends electrically connected to a pair of plug connectors, the communication cable comprising:
two first differential pairs that transmit a high-speed differential signal;
not less than one power wire and not less than one ground wire that supply power to a device connected to the terminal end; and
a configuration channel wire to detect front/back orientation of the plug connectors,
wherein any first differential pairs other than the two first differential pairs are not included.

2. The communication cable according to claim 1, wherein a signal wire constituting the first differential pair comprises a conductor at the center and an insulation layer covering the conductor, and a ratio of a conductor diameter of the conductor to a cable diameter is not less than 0.06.

3. The communication cable according to claim 2, wherein each of the power wire and the ground wire comprises a conductor and an insulation layer covering the conductor, a ratio of conductor diameters of the conductors of the power wire and the ground wire to the cable diameter is not less than 0.10, and when including a plurality of the power wires and a plurality of the ground wires, each of the conductor diameters is a conductor diameter converted so as to be equivalent to that of a single wire so that the resistance value is the same.

4. The communication cable according to claim 1, wherein a signal wire constituting the first differential pair comprises a conductor at the center and an insulation layer covering the conductor, and the conductor of the signal wire has a cross-sectional area of not less than 0.06 mm².

5. The communication cable according to claim 4, wherein each of the power wire and the ground wire comprises a conductor and an insulation layer covering the conductor, the conductors of the power wire and the ground wire have a cross-sectional area of not less than 0.30 mm², and when including a plurality of the power wires and a plurality of the ground wires, each of the cross-sectional areas is the sum of respective cross-sectional areas of the conductors.

6. The communication cable according to claim 1, wherein the number of cores is 6 or more and 14 or less.

7. The communication cable according to claim 1, further comprising:
a second power wire.

8. The communication cable according to claim 1, further comprising:
a second differential pair that transmits a low-speed differential signal.

9. The communication cable according to claim 1, wherein instead of the ground wire, a wire material that serves as a ground wire to supply power to a device connected to the terminal end is used.

10. A communication cable assembly, comprising:
the communication cable according to claim 1; and
the pair of plug connectors electrically connected to both terminal ends of the communication cable.

11. The communication cable assembly according to claim 10, wherein one of the pair of plug connectors comprises a circuit element in which a value of power suppliable to the device is recorded.
